(19) United States
(12) Patent Application Publication
(10) Pub. No.: US 2010/0124979 A1
(43) Pub. Date: May 20, 2010

(54) BONUS FOR CONNECTED GAMING DEVICES

(75) Inventor: John F. Acres, Corvallis, OR (US)

Correspondence Address: MARGER JOHNSON & MCCOLLOM, P.C., 210 SW MORRISON STREET, SUITE 400, PORTLAND, OR, 97204, US

(73) Assignee: ACRES-FIORE, INC., Las Vegas, NV (US)

(21) Appl. No.: 12/272,630

(22) Filed: Nov. 17, 2008

(51) Int. Cl. A63F 9/24; A63F 13/00

(52) U.S. Cl. 463/20; 463/25

(57) ABSTRACT

Embodiments of the present invention are directed to a bonusing system and method for gaming devices that are connected to one another. In some embodiments, separate counters are maintained for each choice of wager that each player has. For instance, if a player can bet 1, bet 2, and bet 3, then there are three sets of counters. Each counter has an individual trigger that may be randomly assigned. Each time a player bets, the corresponding counter increments, and each of the players at the connected gaming devices can see the counters accumulating. One bet will satisfy the individual trigger and, in some embodiments, the player who made the bet will win a bonus. In other embodiments, any player of a connected device can win. In either event, the players of the connected devices will not immediately know which player will get the bonus. Eventually the winning player is identified and the bonus awarded.

### FIELD OF THE INVENTION

This disclosure relates generally to network gaming, and more particularly to bonusing systems on networked games.

### BACKGROUND

Networked gaming devices, such as slot machines in casinos, were introduced many years ago, with mixed successes. The gaming networks provided a platform for a “progressive” bonus, which is a bonus award that accumulates a very small portion of each wager to the progressive total. When a player wins the progressive bonus it is typically a very large award. Progressive awards are not often won. Having so many games contribute to the progressive total that is not won very often causes the total of many progressive awards to grow quite large, including some progressives having payouts in the tens of millions of dollars. The large progressive totals attract players who are enticed by the thought of winning such large amounts.

Because progressive bonuses are awarded so infrequently, however, the player does not garner much excitement from each individual game. In other words, although the players like the thought of the potential of winning a large bonus if he or she wins the progressive, which causes the player to play a particular game, such excitement does not translate to long gaming sessions if the games themselves are boring, repetitive, or do not pay out frequently enough to satisfy the player. Casinos must continue to enhance the overall game experience if they wish to draw new players to games and keep the players engaged.

Embodiments of the invention address these and other limitations in the prior art.

### BRIEF DESCRIPTION OF THE DRAWINGS

FIG. 1A is a functional block diagram that illustrates a gaming device according to embodiments of the invention.

FIG. 1B is an isometric view of the gaming device illustrated in FIG. 1A.

FIGS. 2A, 2B, and 2C are detail diagrams of exemplary types of gaming devices according to embodiments of the invention.

FIG. 3 is a functional block diagram of networked gaming devices according to embodiments of the invention.

FIG. 4 is a block diagram of a gaming device illustrating a bonus initiation portion of a bonus system according to embodiments of the invention.

FIGS. 5A, 5B, and 5C are example screens for display on a gaming device illustrating an identification portion of a bonus system according to embodiments of the invention.

FIGS. 6A and 6B are example screens further illustrating an identification portion of the bonus system according to embodiments of the invention.

FIG. 7A, 7B, 7C, 7D, and 7E are example screens for display on a gaming device illustrating a bonus calculation portion of a bonus system according to embodiments of the invention.

FIG. 8 is an example flow diagram illustrating methods of handling simultaneous bonus awards according to embodiments of the application.

FIG. 9 is an example flow diagram of a bonus system according to embodiments of the invention.

### DETAILED DESCRIPTION

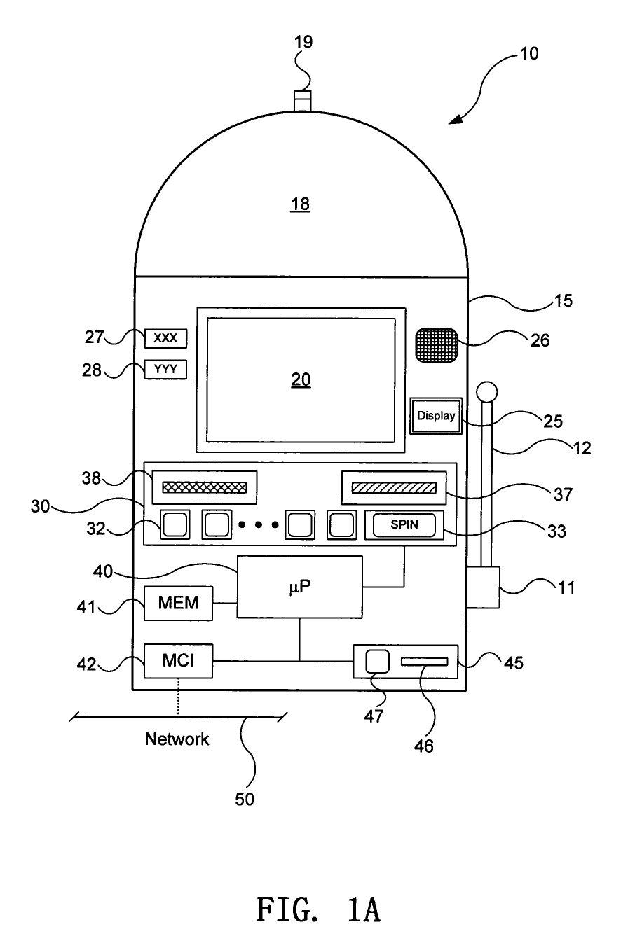

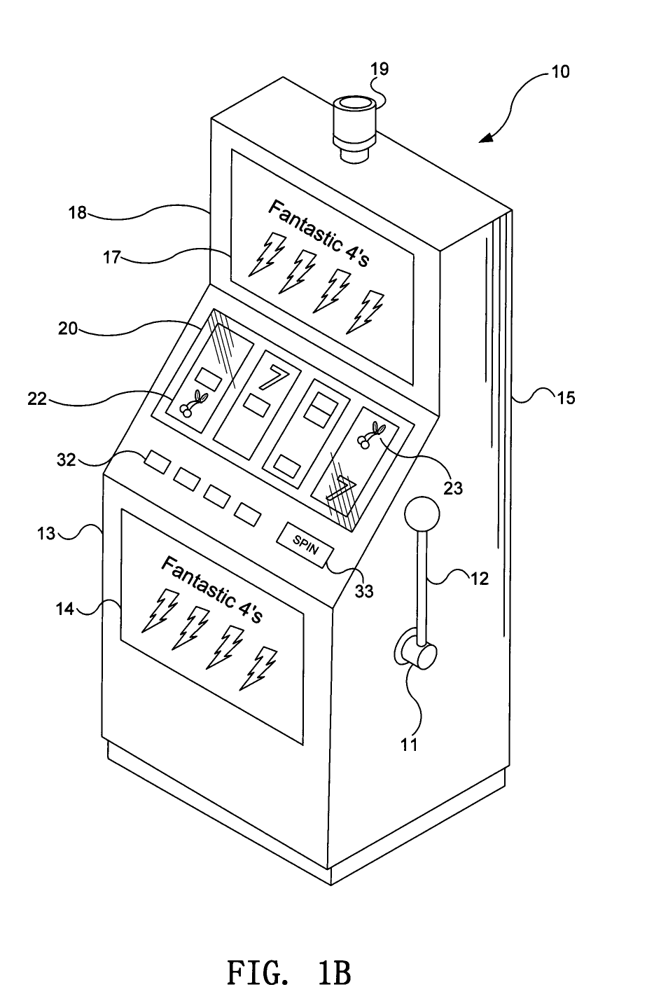

FIGS. 1A and 1B illustrate example gaming devices according to embodiments of the invention.

Referring to FIGS. 1A and 1B, a gaming device 10 is an electronic gaming machine. Although an electronic gaming machine or “slot” machine is illustrated, various other types of devices may be used to wager monetarily based credits on a game of chance in accordance with principles of the invention. The term “electronic gaming device” is meant to include various devices such as electromechanical spinning-reel type slot machines, video slot machines, and video poker machines, for instance. Other gaming devices may include computer-based gaming machines, wireless gaming devices, multi-player gaming stations, modified personal electronic gaming devices (such as cell phones), personal computers, server-based gaming terminals, and other similar devices. Although embodiments of the invention will work with all of the gaming types mentioned, for ease of illustration the present embodiments will be described in reference to the electronic gaming machine 10 shown in FIGS. 1A and 1B.

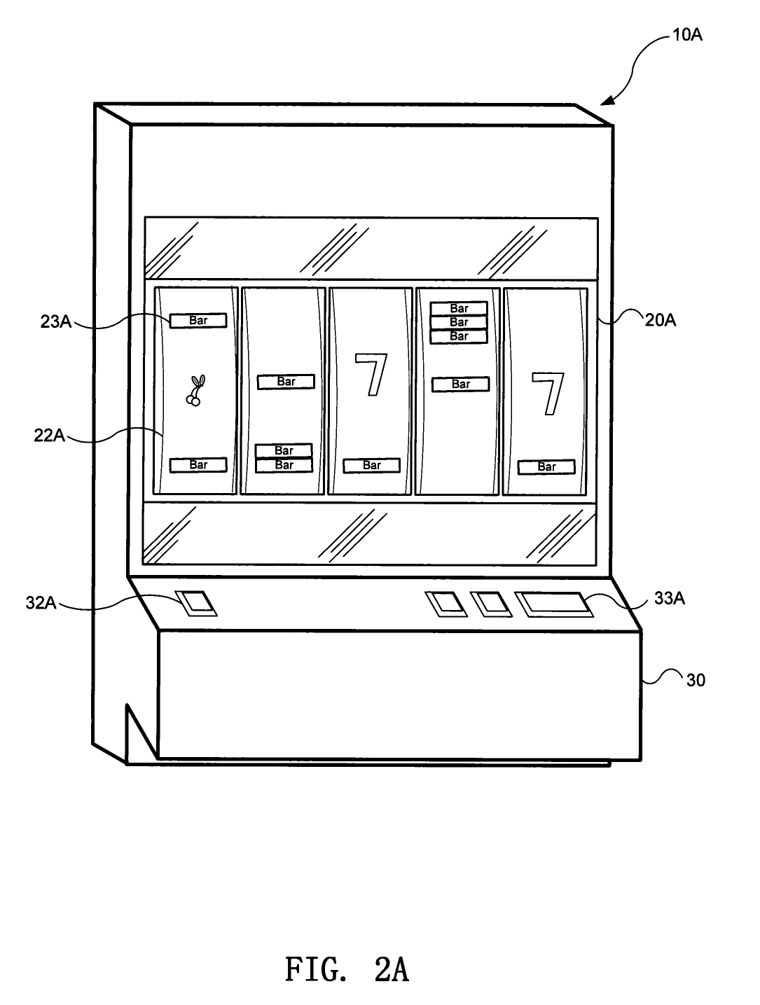

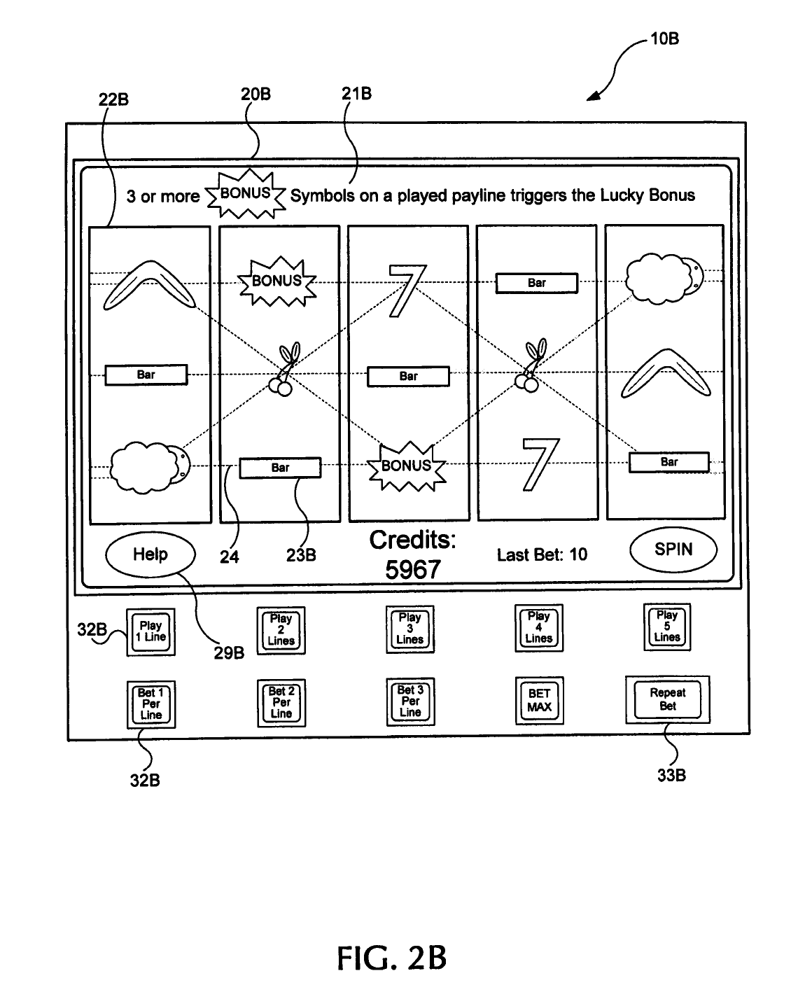

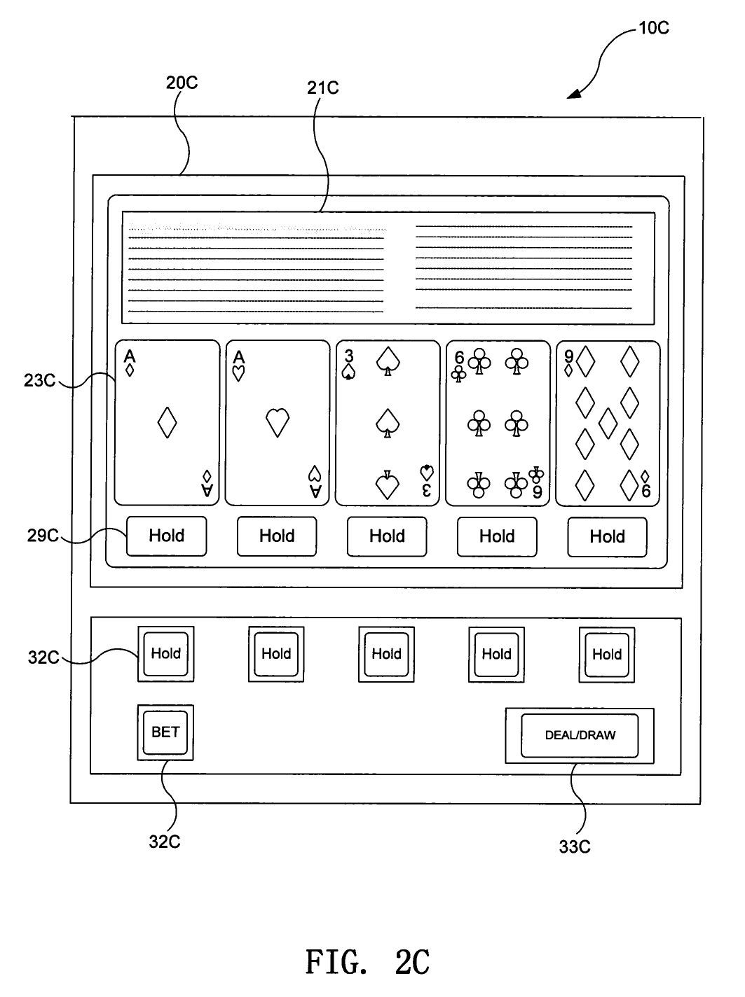

The gaming device 10 includes a cabinet 15 housing components to operate the gaming device 10. The cabinet 15 may include a gaming display 20, a base portion 13, a top box 18, and a player interface panel 30. The gaming display 20 may include mechanical spinning reels (FIG. 2A), a video display (FIGS. 2B and 2C), or a combination of both spinning reels and a video display (not shown). The gaming cabinet 15 may also include a credit meter 27 and a coin-in or bet meter 28. The credit meter 27 may indicate the total number of credits remaining on the gaming device 10 that are eligible to be wagered. In some embodiments, the credit meter 27 may reflect a monetary unit, such as dollars. However, it is often preferable to have the credit meter 27 reflect a number of ‘credits,’ rather than a monetary unit. The bet meter 28 may indicate the amount of credits to be wagered on a particular game. Thus, for each game, the player transfers the amount that he or she wants to wager from the credit meter 27 to the bet meter 28. In some embodiments, various other meters may be present, such as meters reflecting amounts won, amounts paid, or the like. In embodiments where the gaming display 20 is a video monitor, the information indicated on the credit meters may be shown on the gaming display itself 20 (FIG. 2B).

The base portion 13 may include a lighted panel 14, a coin return (not shown), and a gaming handle 12 operable on a partially rotating pivot joint 11. The game handle 12 is traditionally included on mechanical spinning-reel games, where the handle may be pulled toward a player to initiate the spinning of reels 22 after placement of a wager. The top box 18 may include a lighted panel 17, a video display (such as an LCD monitor), a mechanical bonus device (not shown), and a candle light indicator 19. The player interface panel 30 may include various devices so that a player can interact with the gaming device 10.

The player interface panel 30 may include one or more game buttons 32 that can be actuated by the player to cause the gaming device 10 to perform a specific action. For example, some of the game buttons 32 may cause the gaming device 10 to bet a credit to be wagered during the next game, change the number of lines being played on a multi-line game, cash out the credits remaining on the gaming device (as indicated on the credit meter 27), or request assistance from casino personnel, such as by lighting the candle 19. In addition, the player interface panel 30 may include one or more game actuating buttons 33. The game actuating buttons 33 may initiate a game with a pre-specified amount of credits. On some gaming devices 10 a “Max Bet” game actuating button 33 may be included that places the maximum credit wager on a game and initiates the game. The player interface panel 30 may further include a bill acceptor 37 and a ticket printer 38. The bill acceptor 37 may accept and validate paper money or previously printed tickets with a credit balance. The ticket printer 38 may print out tickets reflecting the balance of the credits that remain on the gaming device 10 when a player cashes out by pressing one of the game buttons 32 programmed to cause a ‘cashout.’ These tickets may be inserted into other gaming machines or redeemed at a cashier station or kiosk for cash.

The gaming device 10 may also include one or more speakers 26 to transmit auditory information or sounds to the player. The auditory information may include specific sounds associated with particular events that occur during game play on the gaming device 10. For example, a particularly festive sound may be played during a large win or when a bonus is triggered. The speakers 26 may also transmit “attract” sounds to entice nearby players when the game is not currently being played.

The gaming device 10 may further include a secondary display 25. This secondary display 25 may be a vacuum fluorescent display (VFD), a liquid crystal display (LCD), a cathode ray tube (CRT), a plasma screen, or the like. The secondary display 25 may show any combination of primary game information and ancillary information to the player. For example, the secondary display 25 may show player tracking information, secondary bonus information, advertisements, or player selectable game options.

The gaming device 10 may include a separate information window (not shown) dedicated to supplying any combination of information related to primary game play, secondary bonus information, player tracking information, secondary bonus information, advertisements or player selectable game options. This window may be fixed in size and location or may have its size and location vary temporally as communication needs change. One example of such a resizable window is International Game Technology's “service window”. Another example is Las Vegas Gaming Incorporated's retrofit technology which allows information to be placed over areas of the game or the secondary display screen at various times and in various situations.

The gaming device 10 includes a microprocessor 40 that controls operation of the gaming device 10. If the gaming device 10 is a standalone gaming device, the microprocessor 40 may control virtually all of the operations of the gaming devices and attached equipment, such as operating game logic stored in memory (not shown) as firmware, controlling the display 20 to represent the outcome of a game, communicating with the other peripheral devices (such as the bill acceptor 37), and orchestrating the lighting and sound emanating from the gaming device 10. In other embodiments where the gaming device 10 is coupled to a network 50, as described below, the microprocessor 40 may have different tasks depending on the setup and function of the gaming device. For example, the microprocessor 40 may be responsible for running the base game of the gaming device and executing instructions received over the network 50 from a bonus server or player tracking server. In a server-based gaming setup, the microprocessor 40 may act as a terminal to execute instructions from a remote server that is running game play on the gaming device.

The microprocessor 40 may be coupled to a machine communication interface (MCI) 42 that connects the gaming device 10 to a gaming network 50. The MCI 42 may be coupled to the microprocessor 40 through a serial connection, a parallel connection, an optical connection, or in some cases a wireless connection. The gaming device 10 may include memory 41 (MEM), such as a random access memory (RAM), coupled to the microprocessor 40 and which can be used to store gaming information, such as storing total coin-in statistics about a present or past gaming session, which can be communicated to a remote server or database through the MCI 42. The MCI 42 may also facilitate communication between the network 50 and the secondary display 25 or a player tracking unit 45 housed in the gaming cabinet 15.

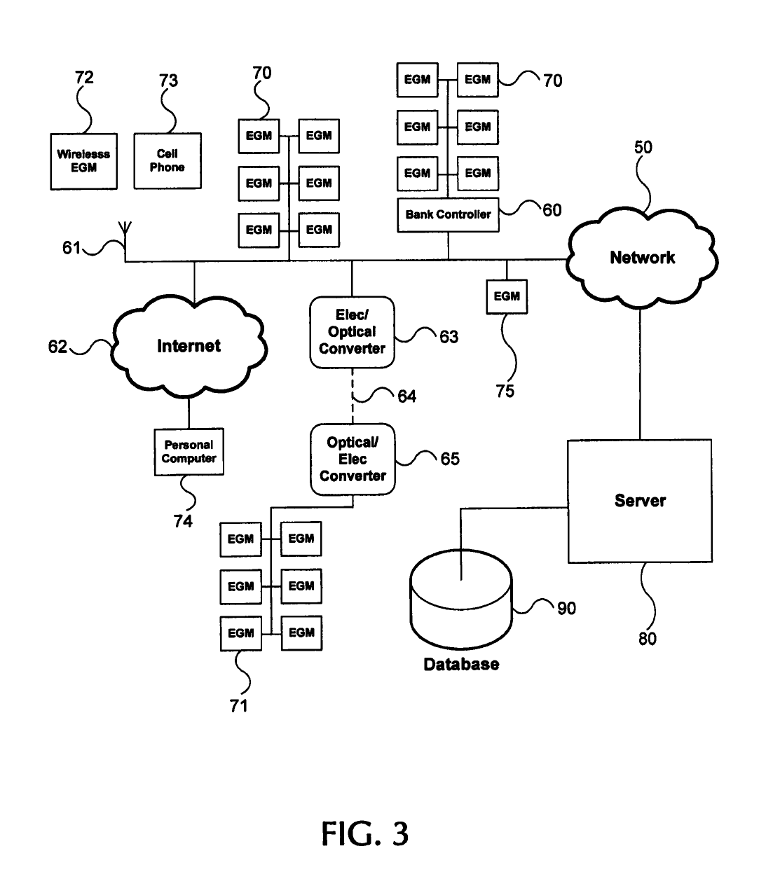

The player tracking unit 45 may include an identification device 46 and one or more buttons 47 associated with the player tracking unit 45. The identification device 46 serves to identify a player, by, for example, reading a player-tracking device, such as a player tracking card that is issued by the casino to individual players who choose to have such a card. The identification device 46 may instead, or additionally, identify players through other methods. Player tracking systems using player tracking cards and card readers 46 are known in the art. Briefly summarizing such a system, a player registers with the casino prior to commencing gaming. The casino issues a unique player-tracking card to the player and opens a corresponding player account that is stored on a server or host computer, described below with reference to FIG. 3. The player account may include the player's name and mailing address and other information of interest to the casino in connection with marketing efforts. Prior to playing one of the gaming devices in the casino, the player inserts the player tracking card into the identification device 46 thus permitting the casino to track player activity, such as amounts wagered, credits won, and rate of play.

To induce the player to use the card and be an identified player, the casino may award each player points proportional to the money or credits wagered by the player. Players typically accrue points at a rate related to the amount wagered, although other factors may cause the casino to award the player various amounts. The points may be displayed on the secondary display 25 or using other methods. In conventional player tracking systems, the player may take his or her card to a special desk in the casino where a casino employee scans the card to determine how many accrued points are in the player's account. The player may redeem points for selected merchandise, meals in casino restaurants, or the like, which each have assigned point values. In some player tracking systems, the player may use the secondary display 25 to access their player tracking account, such as to check a total number of points, redeem points for various services, make changes to their account, or download promotional credits to the gaming device 10. In other embodiments, the identification device 46 may read other identifying cards (such as driver licenses, credit cards, etc.) to identify a player and match them to a corresponding player tracking account. Although FIG. 1A shows the player tracking unit 45 with a card reader as the identification device 46, other embodiments may include a player tracking unit 45 with a biometric scanner, PIN code acceptor, or other methods of identifying a player to pair the player with their player tracking account.

During typical play on a gaming device 10, a player plays a game by placing a wager and then initiating a gaming session. The player may initially insert monetary bills or previously printed tickets with a credit value into the bill acceptor 37. The player may also put coins into a coin acceptor (not shown) or a credit, debit or casino account card into a card reader/authorizer (not shown). One of skill in the art will readily see that this invention is useful with all gambling devices, regardless of the manner in which wager value-input is accomplished.

The credit meter 27 displays the numeric credit value of the money inserted dependent on the denomination of the gaming device 10. That is, if the gaming device 10 is a nickel slot machine and a $20 bill inserted into the bill acceptor 37, the credit meter will reflect 400 credits or one credit for each nickel of the inserted twenty dollars. For gaming devices 10 that support multiple denominations, the credit meter 27 will reflect the amount of credits relative to the denomination selected. Thus, in the above example, if a penny denomination is selected after the $20 is inserted the credit meter will change from 400 credits to 2000 credits.

A wager may be placed by pushing one or more of the game buttons 32, which may be reflected on the bet meter 28. That is, the player can generally depress a “bet one” button (one of the buttons on the player interface panel 30, such as 32), which transfers one credit from the credit meter 27 to the bet meter 28. Each time the button 32 is depressed an additional single credit transfers to the bet meter 28 up to a maximum bet that can be placed on a single play of the electronic gaming device 10. The gaming session may be initiated by pulling the gaming handle 12 or depressing the spin button 33. On some gaming devices 10, a “max bet” button (another one of the buttons 32 on the player interface panel 30) may be depressed to wager the maximum number of credits supported by the gaming device 10 and initiate a gaming session.

If the gaming session does not result in any winning combination, the process of placing a wager may be repeated by the player. Alternatively, the player may cash out any remaining credits on the credit meter 27 by depressing the “cash-out” button (another button 32 on the player interface panel 30), which causes the credits on the credit meter 27 to be paid out in the form of a ticket through the ticket printer 38, or may be paid out in the form of returning coins from a coin hopper (not shown) to a coin return tray.

If instead a winning combination (win) appears on the display 20, the award corresponding to the winning combination is immediately applied to the credit meter 27. For example, if the gaming device 10 is a slot machine, a winning combination of symbols 23 may land on a played payline on reels 22. If any bonus games are initiated, the gaming device 10 may enter into a bonus mode or simply award the player with a bonus amount of credits that are applied to the credit meter 27.

FIGS. 2A to 2C illustrate exemplary types of gaming devices according to embodiments of the invention. FIG. 2A illustrates an example spinning-reel gaming machine 10A, FIG. 2B illustrates an example video slot machine 10B, and FIG. 2C illustrates an example video poker machine 10C.

Referring to FIG. 2A, a spinning-reel gaming machine 10A includes a gaming display 20A having a plurality of mechanical spinning reels 22A. Typically, spinning-reel gaming machines 10A have three to five spinning reels 22A. Each of the spinning reels 22A has multiple symbols 23A that may be separated by blank areas on the spinning reels 22A, although the presence of blank areas typically depends on the number of reels 22A present in the gaming device 10A and the number of different symbols 23A that may appear on the spinning reels 22A. Each of the symbols 22A or blank areas makes up a “stop” on the spinning reel 22A where the reel 22A comes to rest after a spin. Although the spinning reels 22A of various games 10A may have various numbers of stops, many conventional spinning-reel gaming devices 10A have reels 22A with twenty two stops.

During game play, the spinning reels 22A may be controlled by stepper motors (not shown) under the direction of the microprocessor 40 (FIG. 1A). Thus, although the spinning-reel gaming device 10A has mechanical based spinning reels 22A, the movement of the reels themselves is electronically controlled to spin and stop. This electronic control is advantageous because it allows a virtual reel strip to be stored in the memory 41 of the gaming device 10A, where various “virtual stops” are mapped to each physical stop on the physical reel 22A. This mapping allows the gaming device 10A to establish greater awards and bonuses available to the player because of the increased number of possible combinations afforded by the virtual reel strips.

A gaming session on a spinning reel slot machine 10A typically includes the player pressing the “bet-one” button (one of the game buttons 32A) to wager a desired number of credits followed by pulling the gaming handle 12 (FIGS. 1A, 1B) or pressing the spin button 33A to spin the reels 22A. Alternatively, the player may simply press the “max-bet” button (another one of the game buttons 32A) to both wager the maximum number of credits permitted and initiate the spinning of the reels 22A. The spinning reels 22A may all stop at the same time or may individually stop one after another (typically from left to right) to build player anticipation. Because the display 20A usually cannot be physically modified, some spinning reel slot machines 10A include an electronic display screen in the top box 18 (FIG. 1B), a mechanical bonus mechanism in the top box 18, or a secondary display 25 (FIG. 1A) to execute a bonus.

Referring to FIG. 2B, a video gaming machine 10B may include a video display 20B to display virtual spinning reels 22B and various other gaming information 21B. The video display 20B may be a CRT, LCD, plasma screen, or the like. It is usually preferable that the video display 20B be a touchscreen to accept player input. A number of symbols 23A appear on each of the virtual spinning reels 22B. Although FIG. 2B shows five virtual spinning reels 22B, the flexibility of the video display 20B allows for various reel 22B and game configurations. For example, some video slot games 10B spin reels for each individual symbol position (or stop) that appears on the video display 20B. That is, each symbol position on the screen is independent of every other position during the gaming sessions. In these types of games, very large numbers of pay lines or multiple super scatter pays can be utilized since similar symbols could appear at every symbol position on the video display 20B. On the other hand, other video slot games 10B more closely resemble the mechanical spinning reel games where symbols that are vertically adjacent to each other are part of the same continuous virtual spinning reel 22B.

Because the virtual spinning reels 22B, by virtue of being computer implemented, can have almost any number of stops on a reel strip, it is much easier to have a greater variety of displayed outcomes as compared to spinning-reel slot machines 10A (FIG. 2A) that have a fixed number of physical stops on each spinning reel 22A.

With the possible increases in reel 22B numbers and configurations over the mechanical gaming device 10A, video gaming devices 10B often have multiple paylines 24 that may be played. By having more paylines 24 available to play, the player may be more likely to have a winning combination when the reels 22B stop and the gaming session ends. However, since the player typically must wager at least a minimum number of credits to enable each payline 24 to be eligible for winning, the overall odds of winning are not much different, if at all, than if the player is wagering only on a single payline. For example, in a five line game, the player may bet one credit per payline 24 and be eligible for winning symbol combinations that appear on any of the five played paylines 24. This gives a total of five credits wagered and five possible winning paylines 24. If, on the other hand, the player only wagers one credit on one payline 24, but plays five gaming sessions, the odds of winning would be identical as above: five credits wagered and five possible winning paylines 24.

Because the video display 20B can easily modify the image output by the video display 20B, bonuses, such as second screen bonuses are relatively easy to award on the video slot game 10B. That is, if a bonus is triggered during game play, the video display 20B may simply store the resulting screen shot in memory and display a bonus sequence on the video display 20B. After the bonus sequence is completed, the video display 20B may then retrieve the previous screen shot and information from memory, and re-display that image.

Also, as mentioned above, the video display 20B may allow various other game information 21B to be displayed. For example, as shown in FIG. 2B, banner information may be displayed above the spinning reels 22B to inform the player, perhaps, which symbol combination is needed to trigger a bonus. Also, instead of providing a separate credit meter 27 (FIG. 1A) and bet meter 28, the same information can instead be displayed on the video display 20B. In addition, “soft buttons” 29B such as a “spin” button or “help/see pays” button may be built using the touch screen video display 20B. Such customization and ease of changing the image shown on the display 20B adds to the flexibility of the game 10B.

Even with the improved flexibility afforded by the video display 20B, several physical buttons 32B and 33B are usually provided on video slot machines 10B. These buttons may include game buttons 32B that allow a player to choose the number of paylines 24 he or she would like to play and the number of credits wagered on each payline 24. In addition, a max bet button (one of the game buttons 32B) allows a player to place a maximum credit wager on the maximum number of available paylines 24 and initiate a gaming session. A repeat bet or spin button 33B may also be used to initiate each gaming session when the max bet button is not used.

Referring to FIG. 2C, a video poker gaming device 10C may include a video display 20C that is physically similar to the video display 20B shown in FIG. 2B. The video display 20C may show a poker hand of five cards 23C and various other player information 21C including a paytable for various winning hands, as well as a plurality of player selectable soft buttons 29C. The video display 20C may present a poker hand of five cards 23C and various other player information 21C including a number of player selectable soft (touch-screen) buttons 29C and a paytable for various winning hands. Although the embodiment illustrated in FIG. 3C shows only one hand of poker on the video display 20C, various other video poker machines 10C may show several poker hands (multi-hand poker). Typically, video poker machines 10C play “draw” poker in which a player is dealt a hand of five cards, has the opportunity to hold any combination of those five cards, and then draws new cards to replace the discarded ones. All pays are usually given for winning combinations resulting from the final hand, although some video poker games 10C may give bonus credits for certain combinations received on the first hand before the draw. In the example shown in FIG. 2C a player has been dealt two aces, a three, a six, and a nine. The video poker game 10C may provide a bonus or payout for the player having been dealt the pair of aces, even before the player decides what to discard in the draw. Since pairs, three of a kind, etc. are typically needed for wins, a player would likely hold the two aces that have been dealt and draw three cards to replace the three, six, and nine in the hope of receiving additional aces or other cards leading to a winning combination with a higher award amount. After the draw and revealing of the final hand, the video poker game 10C typically awards any credits won to the credit meter.

The player selectable soft buttons 29C appearing on the screen respectively correspond to each card on the video display 20C. These soft buttons 29C allow players to select specific cards on the video display 20C such that the card corresponding to the selected soft button is “held” before the draw. Typically, video poker machines 10C also include physical game buttons 32C that correspond to the cards in the hand and may be selected to hold a corresponding card. A deal/draw button 33C may also be included to initiate a gaming session after credits have been wagered (with a bet button 32C, for example) and to draw any cards not held after the first hand is displayed.

Although examples of a spinning reel slot machine 10A, a video slot machine 10B, and a video poker machine 10C have been illustrated in FIGS. 2A-2C, gaming machines and various other types of gaming devices known in the art are contemplated and are within the scope of the invention.

FIG. 3 is a block diagram illustrating networked gaming devices according to embodiments of the invention. Referring to FIG. 3, multiple electronic gaming devices (EGMs) 70, 71, 72, 73, 74, and 75 may be coupled to one another and coupled to a remote server 80 through a network 50. For ease of understanding, gaming devices or EGMs 70, 71, 72, 73, 74, and 75 are generically referred to as EGMs 70-75. The term EGMs 70-75, however, may refer to any combination of one or more of EGMs 70, 71, 72, 73, 74, and 75. Additionally, the gaming server 80 may be coupled to one or more gaming databases 90. These gaming network 50 connections may allow multiple gaming devices 70-75 to remain in communication with one another during particular gaming modes such as tournament play or remote head-to-head play. Although some of the gaming devices 70-75 coupled on the gaming network 50 may resemble the gaming devices 10, 10A, 10B, and 10C shown in FIGS. 1A-1B and 2A-2C, other coupled gaming devices 70-75 may include differently configured gaming devices. For example, the gaming devices 70-75 may include traditional slot machines 75 directly coupled to the network 50, banks of gaming devices 70 coupled to the network 50, banks of gaming devices 70 coupled to the network through a bank controller 60, wireless handheld gaming machines 72 and cell phones 73 coupled to the gaming network 50 through one or more wireless routers or antennas 61, personal computers 74 coupled to the network 50 through the internet 62, and banks of gaming devices 71 coupled to the network through one or more optical connection lines 64. Additionally, some of the traditional gaming devices 70, 71, and 75 may include electronic gaming tables, multi-station gaming devices, or electronic components operating in conjunction with non-gaming components, such as automatic card readers, chip readers, and chip counters, for example.

Gaming devices 71 coupled over an optical line 64 may be remote gaming devices in a different location or casino. The optical line 64 may be coupled to the gaming network 50 through an electronic to optical signal converter 63 and may be coupled to the gaming devices 71 through an optical to electronic signal converter 65. The banks of gaming devices 70 coupled to the network 50 may be coupled through a bank controller 60 for compatibility purposes, for local organization and control, or for signal buffering purposes. The network 50 may include serial or parallel signal transmission lines and carry data in accordance with data transfer protocols such as Ethernet transmission lines, Rs-232 lines, firewire lines, USB lines, or other communication protocols. Although not shown in FIG. 3, substantially the entire network 50 may be made of fiber optic lines or may be a wireless network utilizing a wireless protocol such as IEEE 802.11a, b, g, or n, Zigbee, RF protocols, optical transmission, near-field transmission, or the like.

As mentioned above, each gaming device 70-75 may have an individual processor 40 (FIG. 1A) and memory 41 to run and control game play on the gaming device 70-75, or some of the gaming devices 70-75 may be terminals that are run by a remote server 80 in a server based gaming environment. Server based gaming environments may be advantageous to casinos by allowing fast downloading of particular game types or themes based on casino preference or player selection. Additionally, tournament based games, linked games, and certain game types, such as BINGO or keno may benefit from at least some server 80 based control.

Thus, in some embodiments, the network 50, server 80, and database 90 may be dedicated to communications regarding specific game or tournament play. In other embodiments, however, the network 50, server 80, and database 90 may be part of a player tracking network. For player tracking capabilities, when a player inserts a player tracking card in the card reader 46 (FIG. 1A), the player tracking unit 45 sends player identification information obtained on the card reader 46 through the MCI 42 over the network 50 to the player tracking server 80, where the player identification information is compared to player information records in the player database 90 to provide the player with information regarding their player account or other features at the gaming device 10 where the player is wagering. Additionally, multiple databases 90 and/or servers 80 may be present and coupled to one or more networks 50 to provide a variety of gaming services, such as both game/tournament data and player tracking data.

The various systems described with reference to FIGS. 1-3 can be used in a number of ways. For instance, the systems can be used to track data about various players. The tracked data can be used by the casino to provide additional benefits to players, such as extra bonuses or extra benefits such as bonus games and other benefits as described above. These added benefits further entice the players to play at the casino that provides the benefits.

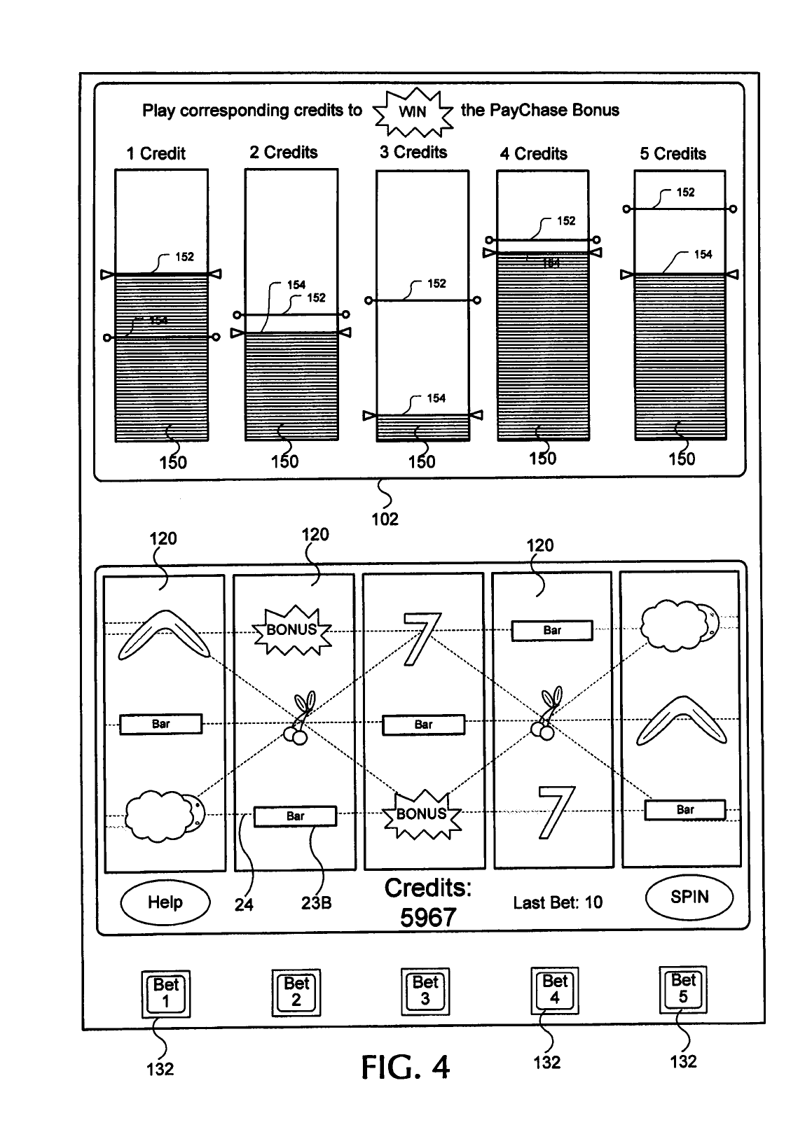

FIG. 4 is a block diagram of a bonus system or bonus game 100 that can be played on a gaming device 10 in FIG. 1. The bonus game 100 is preferably separate and distinct from the main game played on the gaming device 10, although actions the player takes in the base game may be related to the bonus game 100, as described below. In other embodiments the bonus game 100 is an integral part of the base game. The below-described bonus is designed to be played on a group of linked gaming devices, but could also be implemented as a stand-alone bonus game. With reference back to FIG. 3, a bank controller 60 is coupled to a number of EGMs 70 all within the same bank. FIG. 3 also separately shows EGMs 70 coupled to one another in a bank without use of the bank controller 60. Embodiments of the invention are best exemplified when a group of connected gaming devices 70 are located physically near one another, which can build excitement for the nearby players, as described below. In some embodiments on a casino floor, multiple separate bonus games 100 could each be operating, one for each bank or bank portion of the connected gaming devices 70.

With reference back to FIG. 4, a main bonus screen 102, which may be shown on an LCD or other display panel, can be located in the top box 18 of FIG. 1A. Also illustrated in FIG. 4 are a set of reels on a gaming display 120 and a set of game buttons 132. Operating the bonus game 100 on a reel game is just an example embodiment, and the bonus can be operated in conjunction with any type of game, such as those described above. As described above, in play, a player bets a particular wager using the game buttons 132. Game play then commences and a base game outcome is determined.

An initial portion of the bonus game 100 for connected gaming devices 70 described herein centers around the main bonus screen 102. The bonus game 100 includes a set of counters 150, each aligning with one of the bet options of the game buttons 132. For example, one of the counters is associated with the “bet-1” action. Thus, when the player presses the bet-1 button on the base game, or otherwise bets one credit, the 1-credit counter 150 is incremented. Each of the counters 150 includes a present level line 152, as illustrated in FIG. 4. The present level line 152, which is separate for each counter 150, increments each time a particular corresponding wager is made by any of the players of connected gaming devices 70 in their respective games. For example, if there are ten gaming devices 70 coupled to one another, the main bonus screen 102 will look identical, with the same counters 150 and present level lines 152 on each of the ten machines. When any of the players of the connected gaming devices 70 bet 1, the bet-1 counter 150 on each of the main bonus screens 102 increments for all the respective gaming devices 70 and the new present level line is reflected on all the main bonus screens 102 on all the coupled gaming devices.

Also illustrated in FIG. 4 is an indicator 154 on each counter 150 that shows to the player the previous satisfied trigger level that triggered the bonus round for the particular counter. Each of the counters 150 on the example bonus screen 102 includes its own present level line 152 and its own previously satisfied trigger indicator 154, although such implementation details are left to the game designer. For instance, in some embodiments the previously satisfied trigger indicator level may not be displayed at all.

Each of the counters 150 on the bonus screen 102 additionally includes a “present” or “current” trigger level, which is not shown to any players of the connected gaming devices 70. The present trigger level is the increment level at which the counter 150 triggers the next phase of the bonus 100. In some embodiments, these trigger levels are randomly set each time the previous trigger is satisfied. In other words, for example, if the bet-2 counter 150 was last triggered at “122,” the new trigger level may be randomly set to anywhere between the minimum of “1” and a maximum of, for example “175.” The new trigger level is then the new level to which the bet-2 counter 150 must reach to trigger the bonus 100 again.

In some embodiments, the triggers are not completely randomly set, but instead are weighted to cause them to trend toward a particular target or target range. One method of producing a quasi-random trigger is to set the final trigger as the sum of two components. The first component is a random number but the second component has the effect of forcing the resulting trigger into a particular region of the counter. For example, each counter may be broken into five different regions: 1-35 (A), 36-70 (B), 71-105 (C), 106-140 (D), and 141-175 (E) where the second component is the region base number to which the random generated number is added to produce the final trigger result. Such a system is illustrated in Table 1. In Table 1 the randomly generated number is selected between 1 and 35, while the second number is the base number of the weighted region, e.g. 0 for A, 35 for B, etc. As illustrated in Table 1, the region D is purposefully over-represented from its normal random distribution.

TABLE 1

| Random | Region | Trigger Result |
|---|---|---|
| 28 | A (0) | 28 |
| 20 | D (105) | 125 |
| 12 | C (70) | 82 |
| 31 | D (105) | 136 |
| 3 | E (140) | 143 |
| 15 | B (35) | 50 |
| 30 | D (105) | 140 |
| 32 | B (35) | 67 |
| 11 | C (70) | 81 |
| 5 | E (140) | 145 |

Over representing a particular region or regions from its statistical norm will bias the resulting trigger toward the desired range, while keeping the actual trigger result random within that range. There are a myriad number of methods known in the art to implement a quasi-random trigger generator to cause a desired effect and the above example is but one of them.

In the bonus 100, each of the triggers is set somewhere between the first count of the counter, i.e., 1, and the highest possible count of the counter, which may be, e.g., 200. The highest possible count of the counter 150 is the top of the box that contains the counter 150, which is indicated on the bonus screen 102. Therefore a player may be more inclined to make bets that cause a particular counter 150 to go up as it nears the top of the counter, because the bonus is guaranteed to be triggered before the counter reaches the absolute top.

As mentioned above, in some embodiments the bonus screen 102 includes both the present level line 152 and the previous satisfied trigger indicator 154. Because each trigger level is randomly or quasi-randomly set, in some cases the present level line 152 may be above the previously satisfied trigger indicator 154. Such a situation is illustrated with the credit-1 counter 150 of FIG. 4. In other cases, the previous satisfied trigger indicator will be above the actual present level line 152 of the counter. Such examples are shown in counters 2, 3, 4, and 5.

In an alternate embodiment, instead of including a counter for each of the “bet-x” options, where “x” stands for any of the possible wagers, embodiments of the invention may include a single counter that is incremented when any of the linked gaming devices 70 makes any wager. In still another embodiment, there may be only two counters, one for bet-1, bet-2, bet-3, and bet-4, and a separate counter for the bet-5 option. The remainder of the bonus 100 in these embodiments would be the same or similar to that described herein.

In operation, each of the players of the linked gaming devices 70 plays the base game betting one through five credits as desired. If a player sees that one particular counter 150 is nearing the top, or if they are simply feeling lucky, they may bet an amount that corresponds to the particular counter 150. In other instances, the player may simply make the corresponding bet in the base game without reference to the bonus game 100. Eventually, one of the players of the connected gaming devices 70 will satisfy the corresponding trigger for one of the particular counters 150. When that happens, an indicator, such as a sound, image, or series of images, or combination, may indicate to players of the connected gaming devices 70, or other players, that one of the players of the connected gaming devices has won the bonus. In a preferred embodiment, the indicator that notifies that one of the players of the gaming devices 70 has won the bonus does not immediately identify the winning player. Instead, the bonus game 100 builds excitement by informing each of the players of the connected gaming devices 70 that they may have won the bonus 100. Then the bonus 100 enters an identification phase, where the winning player is identified.

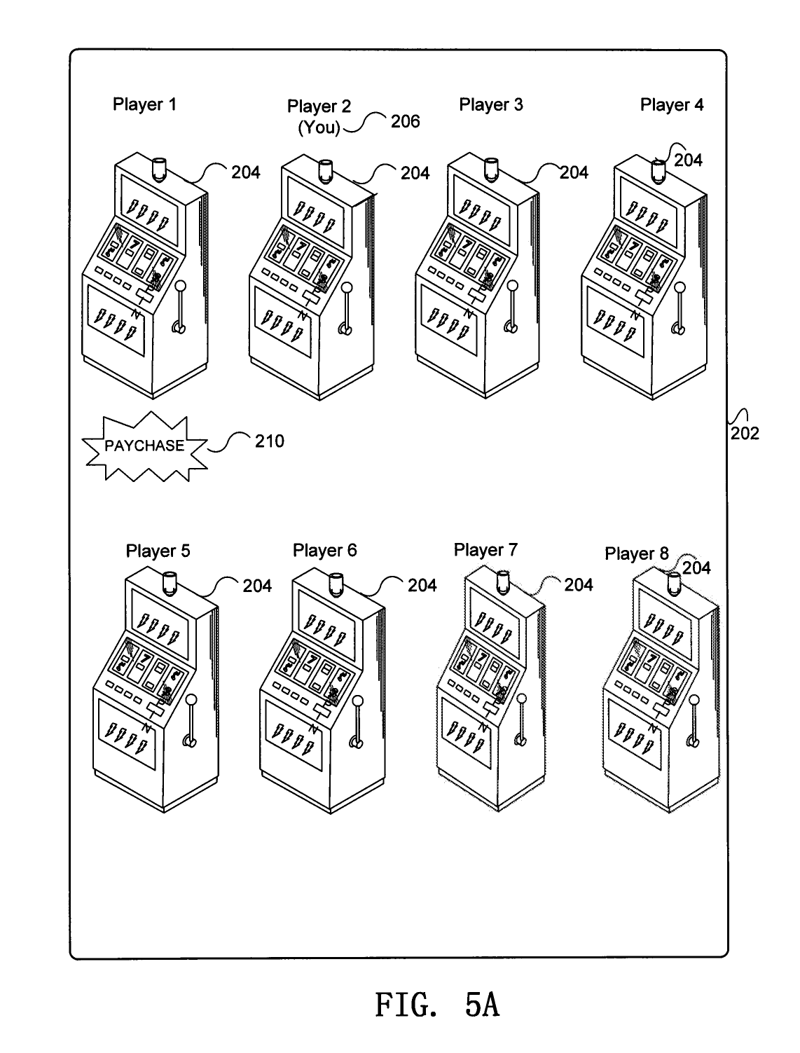

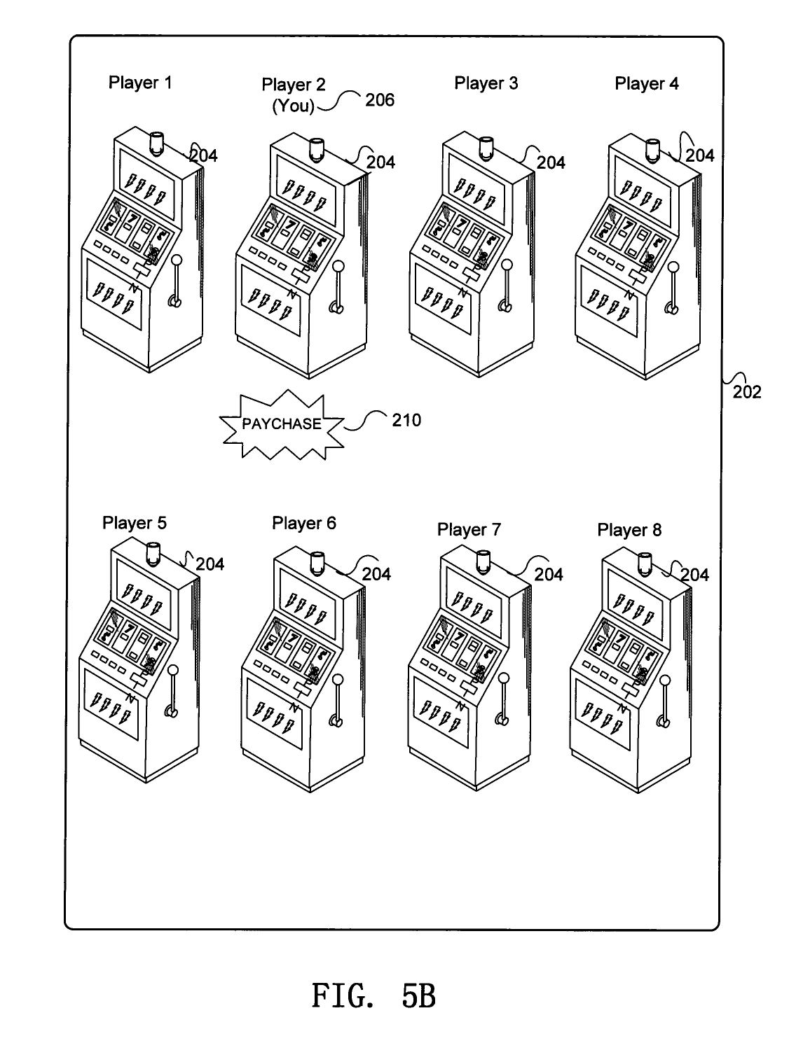

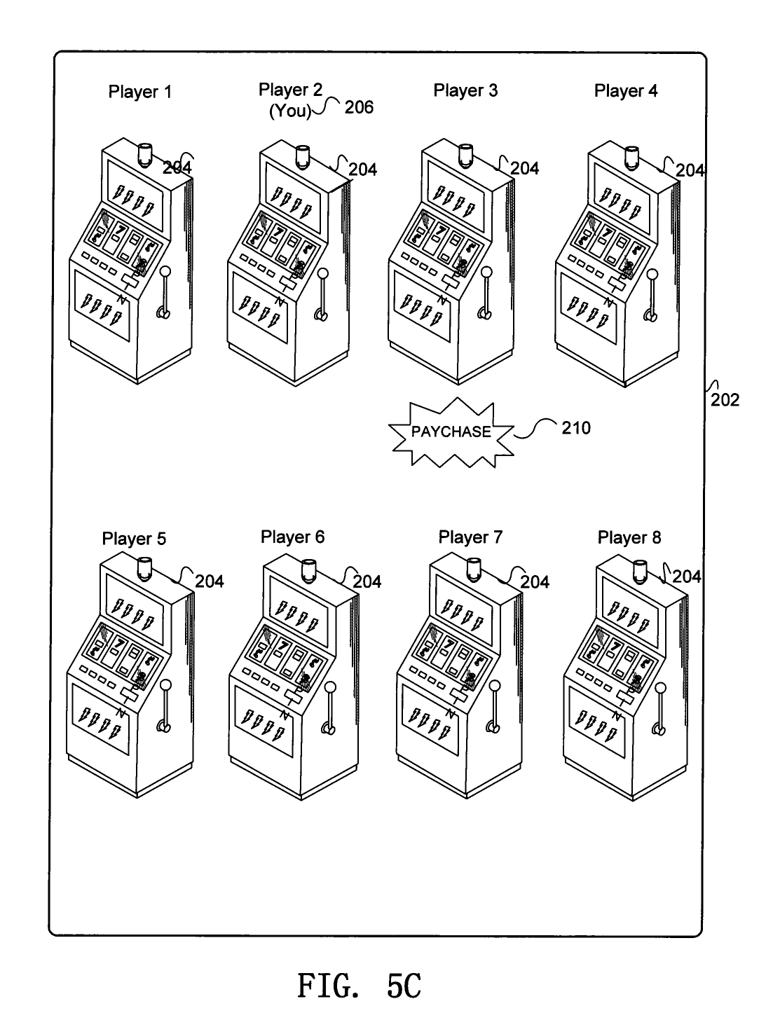

FIG. 5A is an example identification bonus screen 202 that appears on the top box 18 of the connected gaming devices 70 during an identification phase of the bonus 100. In the identification bonus screen 202, each of the connected players is represented by an icon 210 or other indicator that identifies the player's gaming device 70. Additionally, a notification 206 shows each player his or her representation 204. During the identification phase illustrated by the bonus screen 202, an icon 210 moves from one representation 204 to the next, as illustrated between FIG. 5A, 5B, and 5C. In FIG. 5A the icon 210 represents that, if that were the position of the icon 210 when the identification phase of the bonus 100 ended, that player 1 would be the identified winner of the bonus 100. In FIG. 5B the icon 210 is on the representation of player 2's machine, and in FIG. 5C the icon 210 is on the representation of FIG. 3's machine. In some embodiments, the icon moves in a step wise fashion from player one to player two to player three, etc. In other embodiments, the icon 210 can move randomly about the bonus screen 202 in no particular order. In some alternate embodiments, there may be representations that do not even represent connected gaming devices 70, such as a black hole or a “whammy.” However, in the preferred embodiment, the icon 210 moves stepwise from one representation 204 to the next.

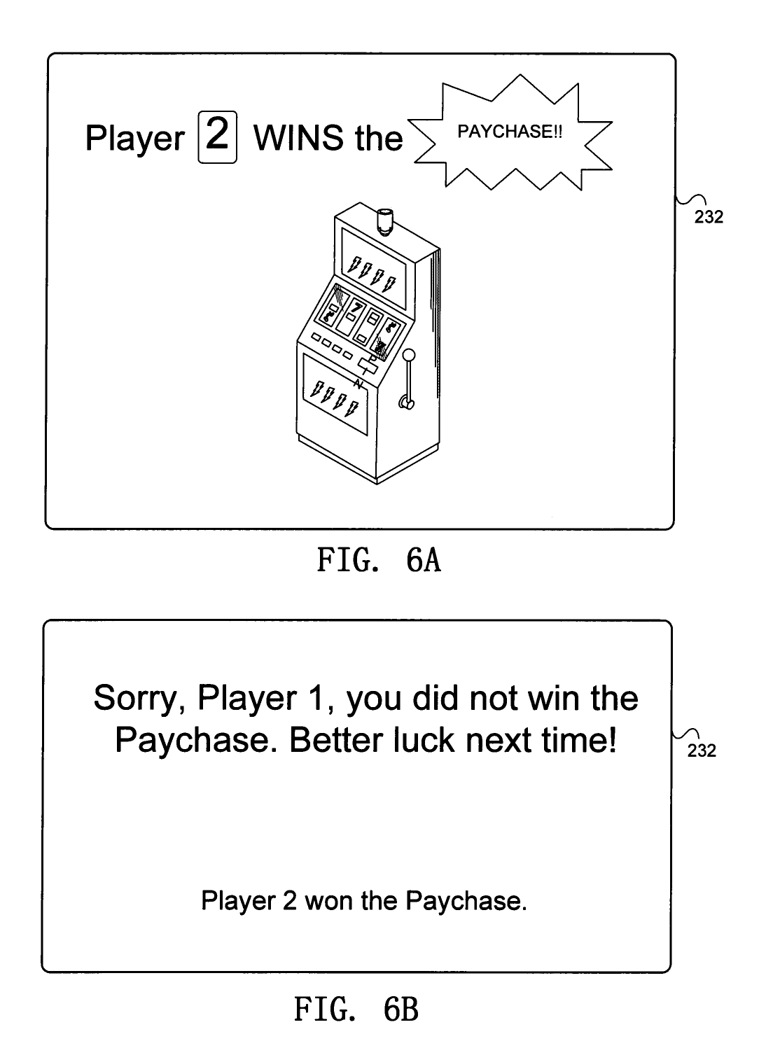

The identification portion of the bonus 100 concludes when the icon 210 permanently lands on a particular representation 204. As illustrated in FIG. 6A, the winner of the bonus 100 is then notified in a screen 222, by lights, video, sound, or a combination of all of the above. The notification can be made to only the players of the connected gaming devices 70 or can include others for a more public notice that builds excitement. In the preferred embodiment the player identified in the identification phase of the bonus 100 is the player whose corresponding bet satisfied the trigger, although the bonus 100 does not require that the player who satisfied the trigger to be the one who receives the bonus award.

Non-winning players of connected gaming devices 70 may be shown a non-winning screen 232, as illustrated on a screen 232 of FIG. 6B. Non-winning players may or may not be informed of the winning player's identity. In some embodiments, non-winning players may also be given a bonus or other award, sometimes referred to as a consolation pay. In still other embodiments, gaming devices that were near the winning player may receive higher consolation pays than other players of the connected gaming devices 70.

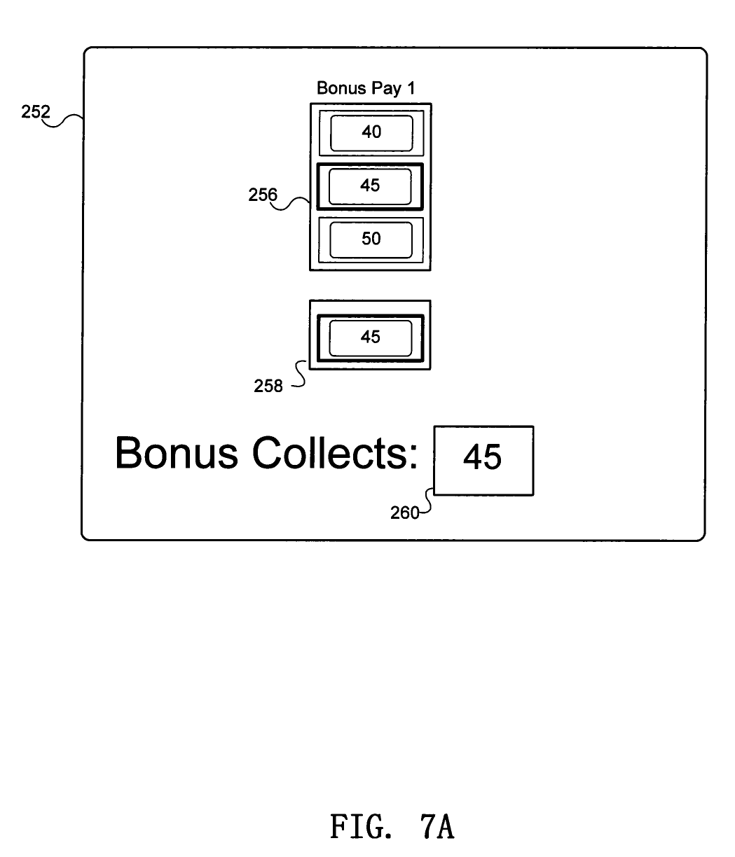

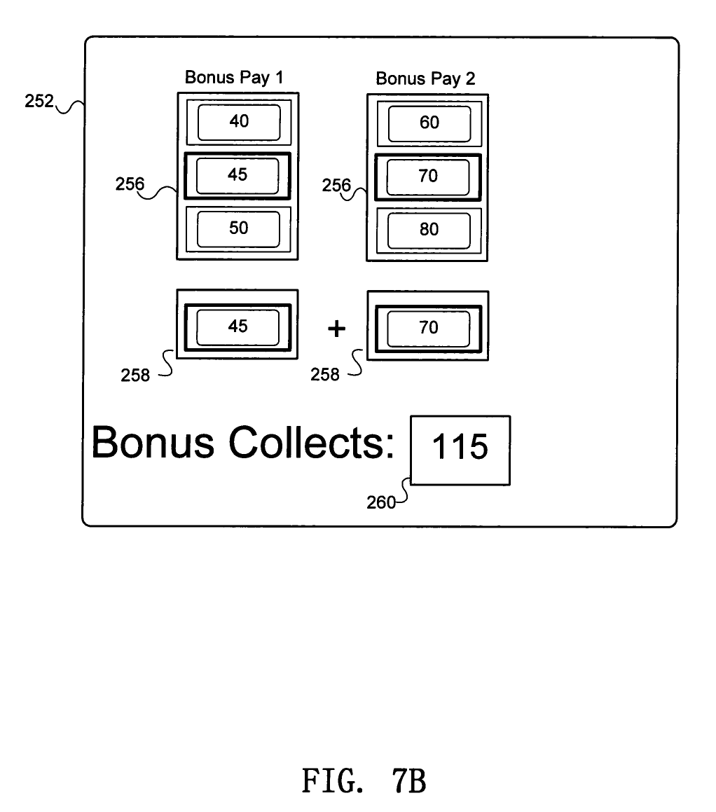

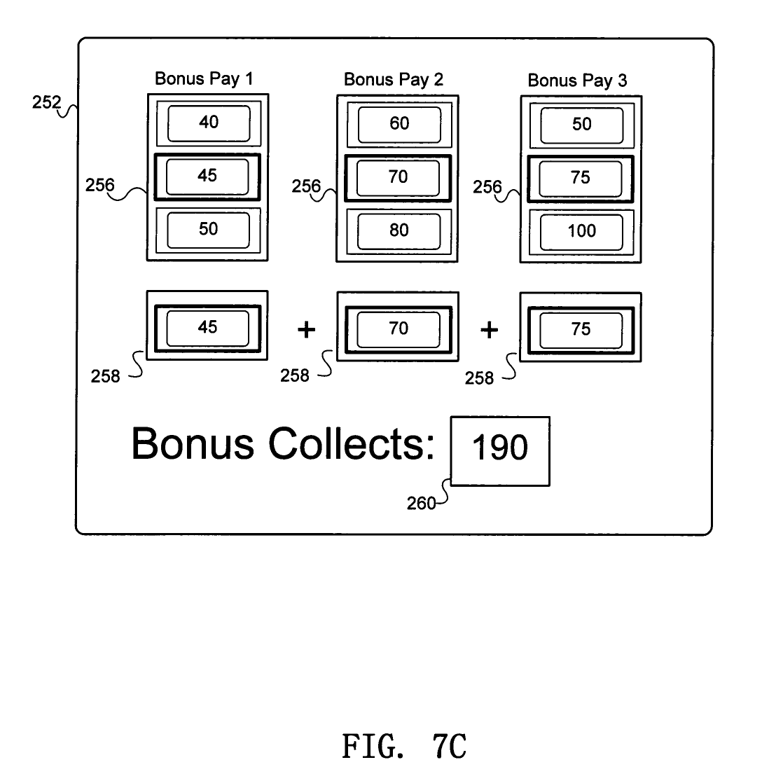

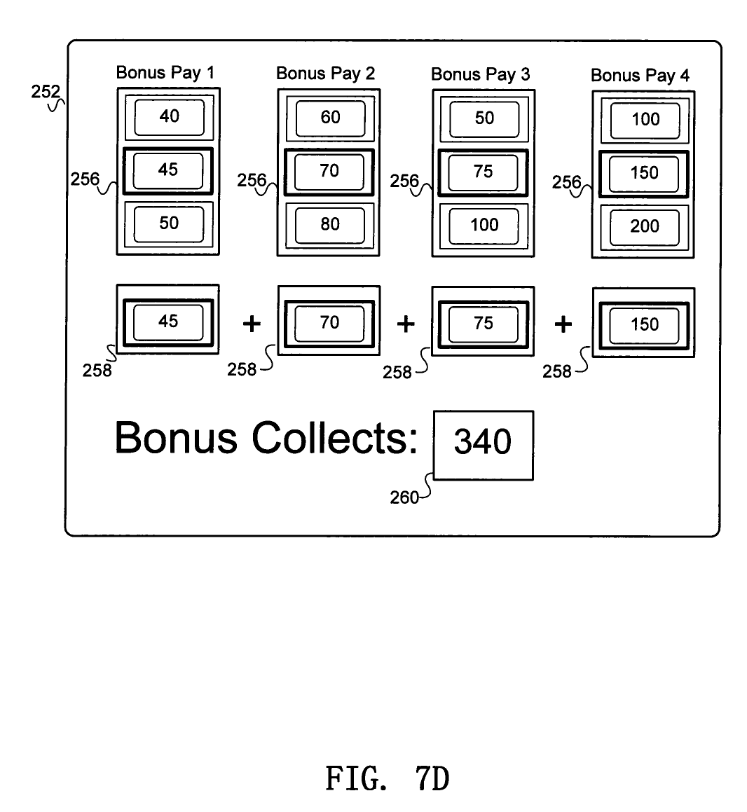

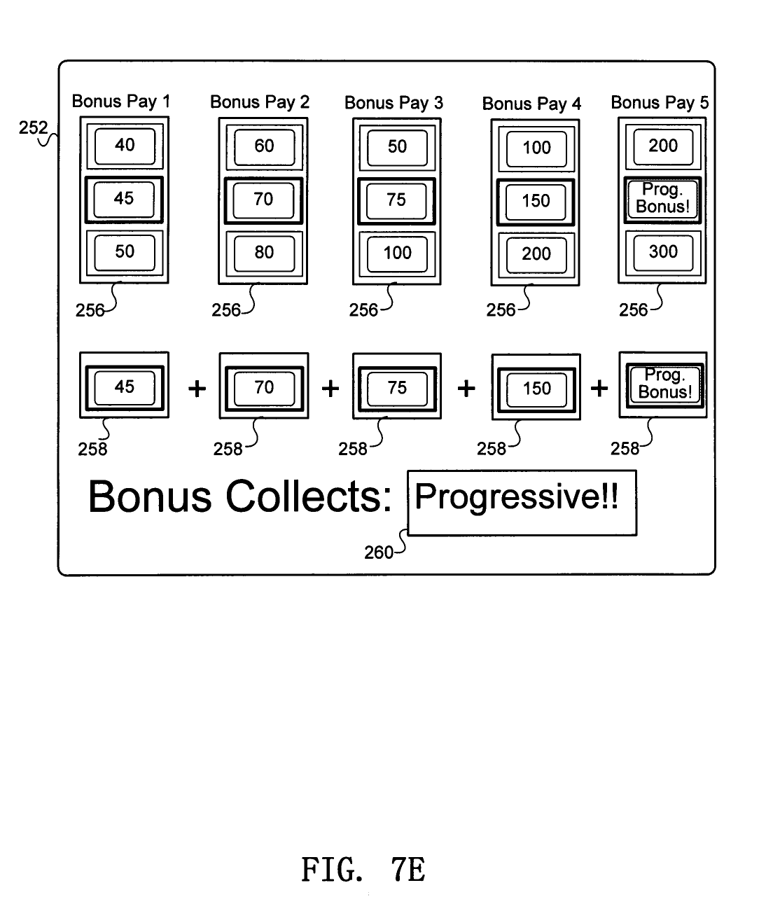

FIGS. 7A-7E illustrate an example bonus determination portion of the bonus 100. In general, in this embodiment, winners of the bonus 100 will win a separate amount for each of the corresponding bets that the winner made when the trigger was satisfied. For example, if the winning player won with a “bet-3”, then the winner will win “Bonus Pay 3” plus the “Bonus Pay 2” plus the “If instead, the winner satisfied the trigger level with a “bet-1”, then the winner of the bonus 100 only wins the “Bonus Pay 1” amount. FIGS. 7A-7E illustrate this embodiment as a series of separate screens, but may be implemented in a single screen or in any informational manner.

FIG. 7A illustrates a first step in calculating the award amount of the bonus 100. A bonus determination screen 252 includes one or more bonus determination panes 256, one for each corresponding bet amount. In a first step, the winning player determines what he or she won on the “Bonus Pay 1” one account. The bonus amount may initiate automatically or may solicit player input to start or stop. In one embodiment, the bonus selector may include a representation of a spinning wheel that the player determines when to stop. In some embodiments, the bonus amount is predetermined, while in other embodiments, the bonus amount is randomly selected from a range. In the embodiment illustrated in FIG. 7A, the bonus determination panel 256 includes by a representation of a spinning wheel having various numbers on particular segments. When initiated, the wheel spins and a number is selected. The selected amount appears in a subtotal pane 258. In this example, the winner won forty-five credits in the “Bonus Pay 1.” If the player won the bonus 100 using the bet-1 button 132, then the bonus amount section of the bonus game 100 is concluded and the forty-five credits are credited to the winning player. If instead the winning player won the bonus amount by pressing the bet-2 button, then the bonus determination process continues as illustrated in FIG. 7B. In FIG. 7B, immediately after the “Bonus Pay 1” amount totals in the bonus pay pane 258, the bonus pane 256 animates and another amount is determined, in this case 70 credits. A total bonus pane 260 includes the totals from “Bonus Pay 1” and “Bonus Pay 2”, in this case 115 credits. If the winning player won the bonus 100 by pressing the bet-3 button 132, then a similar process continues, as illustrated in FIG. 7C. In that case, the winner won 45 credits for “Bonus Pay 1”, 70 credits for “Bonus Pay 2”, and 75 credits for “Bonus Pay 3”, for a total of 190 credits in the total bonus window 260. In some embodiments, as illustrated here, each bonus has a larger potential payout than the preceding bonus. For instance, the “Bonus Pay 4” has a higher potential for winning than “Bonus Pay 3”. FIG. 7D illustrates the case where the winning player won the bonus 100 by pressing the bet-4 button 132, which operates in a similar manner to the one described above.

FIG. 7E illustrates a similar type progression as has been described above. One difference with reference to “Bonus Pay 5,” illustrated in FIG. 7E is that the player who won the bonus 100 with bet-5 is eligible to win the progressive bonus, whereas the progressive bonus is unavailable to those who do not bet-5. In some embodiments the winner can win the progressive bonus only if the player wagered the maximum amount possible.

Although the calculation or determination phase of the bonus 100 is described herein as a series of spinning reels, any alternate method of determining a bonus level is equally acceptable without deviating from the scope of the invention. Further, although the bonuses have been described with reference to credit or monetary bonuses, there are other classes of bonuses that could be awarded in a bonus, such as those that can affect base game play and other types that are described in U.S. patent application Ser. No. 12/166,156, filed Jul. 1, 2008, entitled PLAYER BASED COMPENSATION and incorporated by reference herein.

Other methods of determining or calculating an award amount for the bonus 100 are also acceptable and contemplated. For example, another method determines a bonus by using a multiple that equals or parallels the number of credits wagered that triggered the bonus. As the number of credits increases, so does the multiple. The multiple may be applied to winnings in the base game or to a bonus award. In another embodiment a base-level bonus award is determined after the winning player is revealed. The base-level award may be determined by a spinning wheel described above or by any other method. Then, a multiplier is applied that equals or parallels the number of credits that the winning player wagered. For example, if the player won the bonus using a “bet-4” wager, then the base-level award is multiplied by four and the product credited to the winning player. In the parallel embodiment, the multiplier does not directly equal the number of credits wagered but is instead another number. In such an embodiment the base-level award may be multiplied by 1 for “bet-1,” 2 for “bet-2,” 5 for “bet-3,” 10 for “bet-4” and 20 for “bet-5.” In other words, the multiplier can increase as the number of credits wagered increases, but can be other than a multiple that exactly equals the credits wagered.

Award pools and funding mechanisms for the various bonus awards described above can differ as well. In some instances, each credit multiple adds to a separate award pool. Thus, bet-1 wagers contribute a small percentage to the “Bonus Pay 1” pool while bet-2 wagers contribute to the separate “Bonus Pay 2” pool. In other embodiments there is a single award pool for all of the separate “Bonus Pays.” In still other embodiments each wager contributes to the particular related pool, plus those “below” it. In such an embodiment, a bet-4 wager contributes an amount to each of the Bonus Pay 4, Bonus Pay 3, Bonus Pay 2, and Bonus Pay 1 pools. Other funding mechanisms operate similarly but in the opposite direction, such that a bet-4 wager contributes only to the Bonus Pay 4 and Bonus Pay 5 pools. These various embodiments are implementation specific and embodiments of the invention are not limited to any particular funding mechanism.

In the bonus system 100 the identification of the winning player and determination of the bonus award may be a somewhat lengthy process. Although not required, to maximize revenue any casino implementing the bonus 100 will likely desire that the linked machines 70 be able to continue to play and accept wagers during the bonus identification and determination periods. Because each bonus award is based on a random probability of occurring, it is possible that a subsequent bonus is triggered by a player while the previous bonus winner is still being identified and awarded. In such a situation, it is preferable to complete the awarding of the first bonus before beginning to award the second bonus to eliminate confusion and build excitement, etc. It may be even more preferable to delay paying the second bonus award for a minimum time after the first bonus has been awarded.

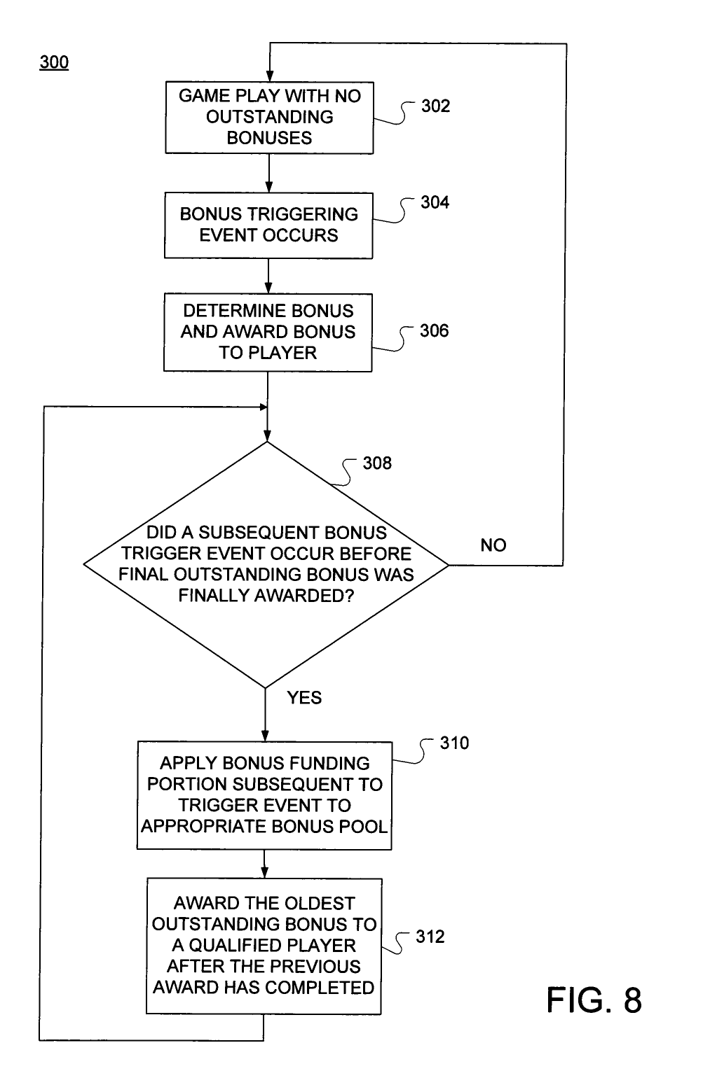

FIG. 8 illustrates an example flow 300 that operates in such a situation. A flow 300 begins at 302 with gameplay on linked machines 70 having no outstanding bonuses. At process 304 a bonus trigger occurs and the bonus winner is identified and compensated in a process 306 as has been described in detail above.

A process 308 determines whether a subsequent bonus was triggered while the player in the process 306 was being identified and awarded. If no such subsequent bonus occurred, the process 308 exits in the NO direction and play returns to normal, with no outstanding bonuses, at the process 302. Instead if a subsequent bonus trigger did occur, the process 308 exits in the YES direction to a process 310. In that process the bonus pool (described above) is immediately fixed when the bonus trigger is satisfied and any subsequent play accumulates toward the next (yet to be triggered) bonus award pool. For example if the first bonus triggered Bonus 4 at 140 credits and shortly thereafter the Bonus 2 triggered, then awarding the Bonus 2 award would be held in abeyance until the Bonus 4 award was complete. All bet-2 credit after the Bonus 2 was triggered accumulates toward a new Bonus 2 award pool, even though the previous Bonus 2 award has yet to be paid. Likewise, all “bet-x” play is credited to its associated Bonus Pool as described above. This funding for the various bonus pools occurs in the process 310.

In a process 312 the Bonus award that was held in abeyance is awarded after the preceding bonus award is completely finished. In the previous award process 306, the bonus was awarded to the player who caused the trigger event because the identification and determination portions occurred immediately after the trigger event occurred. Differently in process 312, the awarding may be a relatively long time after the actual trigger event that caused the particular bonus to be triggered, and the player who caused the trigger event may not even be still playing. In such a situation, or even as a general procedure, the bonus system 100 may determine to award bonuses that were held in abeyance to any qualified player.

In one embodiment of a bonus that is not necessarily awarded to the player who satisfied the bonus trigger, the bonus system 100 may award the already-triggered bonus to a randomly selected player after a minimum playing threshold is reached. For example, the bonus system 100 may select the 15^{th} player who plays the wager corresponding to the already-triggered bonus and award that player the bonus, even if the player who caused the bonus were still actively playing. For example, assume Anna and Bob were playing at linked gaming devices 70 and both always wagering “bet-3.” Further, assume that Clayton was also playing a linked gaming device 70 and always wagering “bet-5.” Clayton wins the Bonus 5. During the awarding of the Bonus 5, both Anna and Bob continue to wager “bet-3,” and Anna triggers the “bet-3” bonus, but it isn't immediately awarded because the bonus system 100 is still awarding the Bonus 5 to Clayton. Finally the Bonus 5 awarding is complete and Clayton continues to wager “bet-5.” After Clayton receives his bonus a duration counter begins counting each instance when a “bet-3” wager is made. Both Anna and Bob continue to wager “bet-3,” and Bob makes the 15^{th} wager. In this embodiment, the bonus system 100 awards the Bonus 3 to Bob, in the process 312 of FIG. 8, because Bob made the 15^{th} bet-3 wager after the initialization of the duration counter, even though Anna is still actively playing the game.

Of course, in this example the 15^{th} wager was arbitrary, and any reasonable number could be selected as an implementation detail. Because a casino may wish to keep the spacing between awards short, it may be preferable to keep the number of wagers to satisfy the duration counter relatively low, such as between 2 and 25.

There are other ways to implement a fair selection process to award bonuses that had their awards delayed. One implementation method can be based on time, e.g., the first player who wagers a corresponding “bet-x” wager after 30 seconds from the time the previous bonus award completed wins the second bonus, regardless of who triggered the second bonus. Other methods could use triggers tied to game events, such as a losing base game outcome. There are many other methods to implement a fair selection process appropriate to award the held bonus.

Of course, it would be possible to award the actual player who triggered the subsequent Bonus award if the player was known to the Bonus system 100. In some embodiments the bonus system 100 awards the bonus to the player who caused the trigger, provided that player is still playing, or even if the player has already stopped playing. In such an embodiment, the bonus system can determine if the identified player was still playing at the gaming device 70 while the player's bonus award was held in abeyance. If so, then the process 312 of FIG. 8 simply awards that player during the next available bonus award period. If instead the player is no longer playing, the bonus could be deposited into the player account of the identified player instead of publically awarding the bonus. In other embodiments the bonus system 100 can award any of the triggered bonuses to any player, regardless of whether or not they caused the bonus trigger.

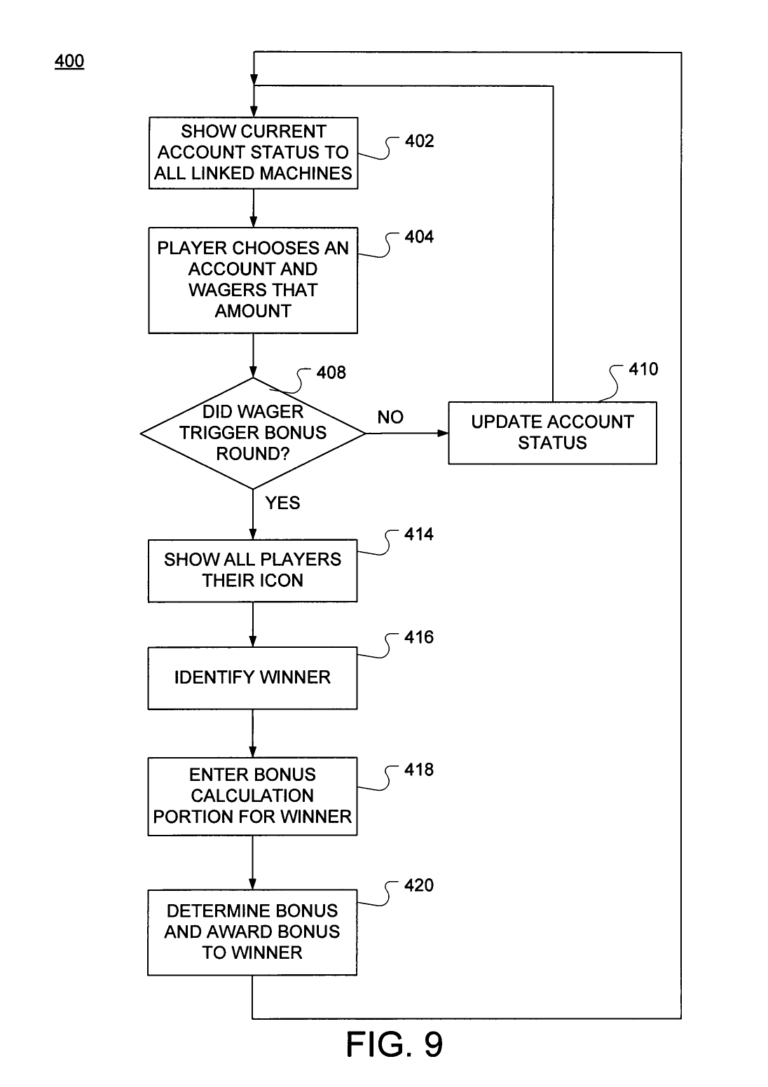

FIG. 9 illustrates an example flow 400 that explains actions in the bonus system 100. The flow 400 begins at a process 402 where the current account status is shown to all of the linked machines 70. For example, this step can be satisfied by showing the main bonus screen 102 as illustrated in FIG. 4 on the top box 18 of all the connected gaming machines 70. Next in a process 404, the player chooses and wagers the desired amount. For example, if the player chooses to increment the three-credit counter 150, then that player would press the bet-3 button 132 of FIG. 4. In a decision process 408, the present counter total is compared against the trigger amount for each counter. If the trigger was not satisfied, the flow 400 exits the decision 408 in the NO direction and the counter status is updated to all the connected devices 70 in a process 410. The flow 400 then continues back to process 402 as described above.

If instead, the wager satisfied the trigger for the particular counter 150, then the flow 400 exits the decision 408 in the YES direction and the bonus 100 enters the identification phase. In a process 414, each player is shown an identifier, such as showing an icon of the particular gaming device on the selection screen 202 as illustrated in FIG. 5A. Next, the winning player is identified in a process 416 that is described in an example process with reference to FIGS. 5A, 5B, 5C, and 6A. After the process 416, the flow 400 enters a bonus calculation phase. In a process 420, a bonus is determined and credited to the award winner. An example of processes satisfying process 420 is illustrated with reference to FIGS. 7A-7E.

Some embodiments of the invention have been described above, and in addition, some specific details are shown for purposes of illustrating the inventive principles. However, numerous other arrangements may be devised in accordance with the inventive principles of this patent disclosure. Further, well known processes have not been described in detail in order not to obscure the invention. Thus, while the invention is described in conjunction with the specific embodiments illustrated in the drawings, it is not limited to these embodiments or drawings. Rather, the invention is intended to cover alternatives, modifications, and equivalents that come within the scope and spirit of the inventive principles set out in the appended claims.

1. A bonus system for a group of connected gaming devices comprising:
a set of counters corresponding to a set of respective potential wagers;
a modifier that increments the corresponding counter when any player of any of the connected gaming devices selects a wager;
a trigger level for each of the set of counters; and
a comparator configured to determine when any trigger of the set of counters has been satisfied.

2. The bonus system of claim 1 in which the trigger levels are randomly set.

3. The bonus system of claim 2 in which the trigger levels are randomly set through a weighted filter.

4. The bonus system of claim 2 in which each of the set of counters has an independent trigger level.

5. The bonus system of claim 1 in which a previous satisfied trigger level is displayed on at least one of the connected gaming devices.

6. The bonus system of claim 1 in which a present level of the set of counters is displayed.

7. A bonus system for a group of connected gaming devices comprising:
a collection of accounts corresponding to a set of respective potential wagers;
an account modifier that increments the corresponding one of the accounts when any player of any of the connected gaming devices selects a wager;
an account trigger for each of the collection of accounts;
a comparator configured to determine when any account trigger of the collection of accounts has been satisfied;
a facility that causes an indication to appear on one or more than one of the connected gaming devices that indicates a chance to win a bonus award; and
a bonus awarder that awards a benefit to a player of one of the connected gaming devices.

8. The bonus system of claim 7 in which the awarded player is the player that made the wager that satisfied the account trigger.

9. The bonus system of claim 7 in which the facility comprises a display driver structured to illustrate an indicator of predetermined of the connected gaming devices.

10. The bonus system of claim 9 in which the predetermined of the connected gaming devices are those of the connected gaming devices having players identified by a player tracking system.

11. The bonus system of claim 7 in which the benefit is a progressive bonus.

12. The bonus system of claim 7 in which each of the collection of accounts includes a randomly set trigger.

13. The bonus system of claim 7 in which a previous satisfying trigger is displayed.

14. The bonus system of claim 7 in which a present level of each of the collection of accounts is displayed.

15. The bonus system of claim 7, further comprising a facility that identifies the awarded player.

16. The bonus system of claim 7 in which the indication is an image or series of images.

17. The bonus system of claim 7 in which the indication is an audio signal.

18. The bonus system of claim 7 in which the awarded player is the player that made a wager that satisfied a trigger for the bonus by selecting a particular wager amount.

19. The bonus system of claim 7 in which the awarded player is a randomly selected player.

20. The bonus system of claim 7 in which each of the players of the connected gaming devices receive an award.

21. The bonus system of claim 19 in which the player who satisfied a trigger for the bonus receives a higher award than the other players of the connected gaming devices.

22. The bonus system of claim 7 in which the facility comprises a display driver structured to illustrate an indicator of predetermined of the connected gaming devices.

23. The bonus system of claim 22 in which the display driver is configured to additionally illustrate an indication of a local one of the connected gaming devices.

24. The bonus system of claim 22 in which the predetermined of the connected gaming devices are those of the connected gaming devices that are being actively played.

25. A bonus award for a gaming device having a selectable credit wager, the bonus comprising:
a base rate; and
a final award amount determined by multiplying the base rate by a number related to the number of selected credits.

26. The bonus award of claim 25 in which the number of selected credits is selected by a user.

27. The bonus award of claim 26 in which the number of credits selected by the user comprises a number of credits wagered by the user in the base game.

28. The bonus award of claim 25, further comprising a separate award pool for each of the selectable credit wagers.

29. The bonus award of claim 25 in which the number related to the number of selected credits equals the number of selected credits.

30. A method of providing a bonus to a player of one of a plurality of linked gaming devices, comprising:
setting a trigger for each of a set of counters;
incrementing individual counters in the set when a player wagers a corresponding amount;
after one of the triggers is satisfied, displaying an indication of selected of the linked gaming devices without identifying a bonus winner;
displaying a winning indication to the gaming device to be awarded a bonus; and
awarding a bonus to a player of one of the plurality of linked gaming devices.

31. The method of claim 30 in which awarding a bonus to a player comprises awarding a bonus to the player of the gaming device that satisfied the trigger.

32. The method of claim 30 in which awarding a bonus to a player comprises awarding a bonus to a randomly selected player.

33. The method of claim 30 in which setting a trigger comprises setting a random trigger.

34. The method of claim 30, further comprising displaying a previous trigger level for at least one of the counters.

35. The method of claim 30, further comprising displaying a present level of each of the set of counters.

36. The method of claim 30, in which awarding a bonus comprises:
randomly determining an award value for at least one of the individual accounts; and
awarding a sum of all of the determined award values to the player as the bonus.

37. The method of claim 30, further comprising awarding a progressive bonus as the bonus.

38. A method for awarding a bonus on a set of linked gaming devices, comprising:
establishing a bonus trigger;
after the bonus trigger has been satisfied, awarding the bonus to a randomly selected player of the linked gaming devices.

39. The method of claim 38 in which awarding the bonus takes a first duration, the method further comprising:
establishing a second bonus trigger; and
if the second bonus trigger is satisfied during the first duration:
establishing an awarding criteria for awarding a second bonus, and
awarding the second bonus to a player that satisfied the awarding criteria.

40. The method of claim 39 in which awarding the second bonus occurs after the conclusion of the first duration.

41. The method of claim 39 in which eligibility for the award criteria begins only after the conclusion of the first duration.

42. The method of claim 39 in which the awarding criteria comprises a minimum number of credits played on the linked gaming devices after the second bonus trigger is satisfied.

43. The method of claim 39 in which the awarding criteria comprises a minimum time duration after the second bonus trigger is satisfied.

44. The method of claim 39, further comprising, after the second bonus trigger is satisfied, attributing a percentage of wagers of the linked gaming devices to a third bonus pool.

45. The method of claim 39 in which every bonus awarded is awarded in the order in which its corresponding trigger was satisfied.

46. A method for awarding a bonus on a set of linked gaming devices, comprising:
establishing a first and a second bonus trigger for a first and a second bonus, respectively;
after the first bonus trigger has been satisfied, awarding the first bonus to a player during a first time period; and
if the second trigger is satisfied during the first time period, delaying awarding of the second bonus until the first time period has concluded.

47. The method of claim 46, further comprising:
establishing a criterion to be satisfied before awarding the second bonus.

48. The method of claim 47 in which the criterion comprises a minimum number of credits played after the second bonus trigger is satisfied.

49. The method of claim 47 in which the criterion comprises a minimum time duration after the second bonus trigger is satisfied.

50. The method of claim 46, further comprising awarding the second bonus to a randomly selected player.

51. The method of claim 47, further comprising awarding the second bonus to a randomly selected player who satisfied the criterion.

52. The method of claim 46, further comprising, after the second bonus trigger is satisfied, preventing additions to bonus pool related to the second bonus.
